(19) United States
(12) Patent Application Publication
(10) Pub. No.: US 2002/0154505 A1
(43) Pub. Date: Oct. 24, 2002

(54) Pipe-type lamp having a controller

(76) Inventor: Wun Fang Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/837,260

(22) Filed: Apr. 19, 2001

(51) Int. Cl. F21V 23/04

(52) U.S. Cl. 362/251; 315/210

(57) ABSTRACT

This invention relates to a pipe-type lamp having a controller, which connects with the light bulb strings in the pipe lamp. Each light bulb string is extended from the controller independently and is controlled to twinkle in regular that obtains a variable decorative lighting effect.

### BACKGROUND OF INVENTION

A pipe-type lamp is widely used, which includes one or more light bulb strings to be assembled in a transparent pipe for decoration. This known structure is only a simple connection of the light bulb string and the pipe. The lighting effect of the prior art is normal and monotonous without attraction.

Accordingly, the primary object of the invention is to provide a pipe-type lamp having a controller, wherein the light bulb strings are connected with the controller to provide various lighting effects and to increase decorative purpose. Now the features and advantages of the invention will be described in detail with reference to the accompanying drawings.

### BRIEF DESCRIPTION OF THE INVENTION

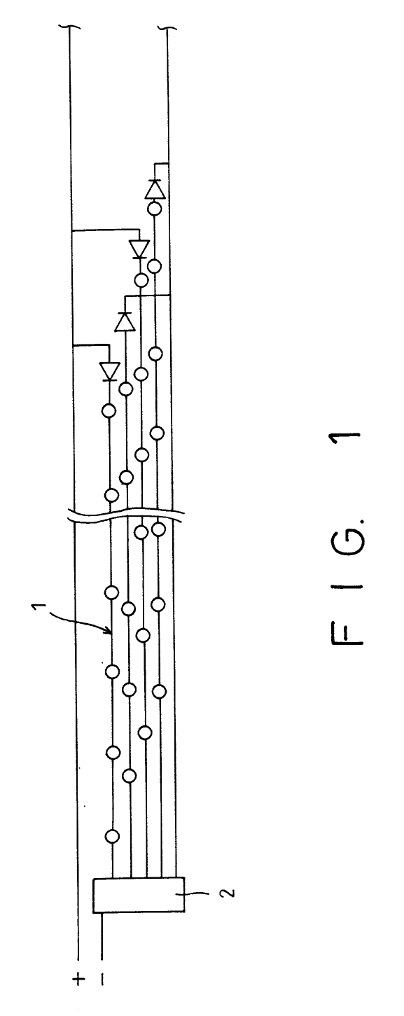

FIG. 1 is a schematic plan view showing a connection between the light bulb strings and the controller according to the present invention.

### DETAILED DESCRIPTION OF THE INVENTION

Please refer to FIG. 1, the invention relates to an improvement of a pipe-type lamp, which includes several light bulb strings (1) therein. The characteristic of this invention is in that a controller (2) is provided in the pipe lamp. Each light bulb string (1) is extended independently from the controller (2). Under a certain IC design of the controller, the light bulb string (1) can be sparkled in regular to display a variable decoration. It is to be understood that the pipe-type lamp of the present invention can provide a special decorative lighting and twinkling effect.

Therefore, the present invention improves the lighting effect of the known pipe-type lamp with variable twinkling decoration. Under the control of the controller, the light bulb strings in the pipe lamp can be sparkled in regular that obtains the predicted improvement. Evidently it meets the requirements of granting a patent. We hereby file an application for a patent grant.

What is claimed is:

1. A pipe-type lamp having a controller including a transparent pipe and several inner light bulb strings, wherein a controller being provided in the pipe, and each light bulb string being connected with the controller independently to be controlled for variable twinkling effect.
